(19) United States
(12) Patent Application Publication
(10) Pub. No.: US 2024/0320504 A1
(43) Pub. Date: Sep. 26, 2024

(54) Non-Uniform Pessimistic Reinforcement Learning

(71) Applicant: INTERNATIONAL BUSINESS MACHINES CORPORATION, ARMONK, NY (US)

(72) Inventors: Ryo Iwaki, Tokyo (JP); Takayuki Osogami, Yamato-shi (JP)

(21) Appl. No.: 18/187,401

(22) Filed: Mar. 21, 2023

(51) Int. Cl. G06N 3/092

(52) U.S. Cl. CPC G06N 3/092

(57) ABSTRACT

A method for performing offline distributional reinforcement learning. The method includes randomly sampling a dataset comprising historical training data between an agent and an environment to generate a minibatch of the historical training data; updating a plurality of predictors, using non-uniform underestimation, based on the minibatch; and updating a policy using the updated plurality of predictors and the minibatch.

### BACKGROUND

Offline reinforcement learning, also known as batch reinforcement learning, is a type of reinforcement learning where an agent learns from a fixed dataset of previously collected data, rather than interacting with the environment in real-time. In offline reinforcement learning, the dataset of past experiences is typically collected by another agent or a human expert, or generated by a simulator. This dataset is then used to train the reinforcement learning agent to learn a policy that maximizes expected reward in the given environment.

One advantage of offline reinforcement learning is that it can be more efficient than online reinforcement learning, as the dataset can be collected in advance and the learning algorithm can be run offline. Additionally, offline reinforcement learning can be used in settings where it is not possible or safe to interact with the environment in real-time, such as in medical or industrial applications.

However, offline reinforcement learning also has some challenges. One challenge is that the dataset may be biased or incomplete, leading to suboptimal policies. Another challenge is that the exploration-exploitation tradeoff is more difficult to manage in offline reinforcement learning, as the agent must rely on the data provided in the dataset rather than actively exploring the environment.

### SUMMARY

The present disclosure includes various embodiments that utilize a non-uniform underestimation approach for offline distribution reinforcement learning that produces a good policy that is more stable than the existing uniform underestimation approach for offline distribution reinforcement learning.

As an example, the present disclosure includes a method for performing offline distributional reinforcement learning. The method includes randomly sampling a dataset comprising historical training data between an agent and an environment to generate a minibatch of the historical training data; updating a plurality of predictors, using non-uniform underestimation, based on the minibatch; and updating a policy using the updated plurality of predictors and the minibatch.

In an embodiment, updating the plurality of predictors, using non-uniform underestimation, based on the minibatch includes computing quantile values using the plurality of predictors for state-action pairs in the minibatch; computing an uncertainty of the quantile values based on a difference in outputs of the plurality of predictors; and updating the plurality of predictors based on the uncertainty of the quantile values.

Still, in another embodiment, updating the policy using the updated plurality of predictors and the minibatch includes sampling actions for corresponding states in the minibatch based on the policy; computing quantile values for the states in the minibatch using the updated plurality of predictors; computing risk measure for the sample actions from the quantile values; and updating the policy so that the risk measure is maximized.

Other embodiments including a system and computer program product configured to perform the above method or various implementations of the above method are further described in the detailed description.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram illustrating reinforcement learning in accordance with an embodiment of the present disclosure.

FIG. 2 is a graph illustrating an example of a return distribution.

FIG. 3 is a graph illustrating a quantile function of a reward distribution in accordance with an embodiment of the present disclosure.

FIG. 4 is schematic diagram illustrating a non-uniform underestimation approach for offline distribution reinforcement learning in accordance with an embodiment of the present disclosure.

FIG. 5 is a graph illustrating an example of a return distribution of a policy that is learned using existing uniform pessimistic approach.

FIG. 6 is a graph illustrating a return distribution of a policy that is learned using a non-uniform pessimistic approach in accordance with an embodiment of the present disclosure.

FIG. 7 is a flowchart illustrating a learning process for performing offline distributional reinforcement learning in accordance with an embodiment of the present disclosure.

FIG. 8 is a block diagram illustrating a hardware architecture of a system according to an embodiment of the present disclosure.

The illustrated figures are only exemplary and are not intended to assert or imply any limitation with regard to the environment, architecture, design, or process in which different embodiments may be implemented.

### DETAILED DESCRIPTION

It should be understood at the outset that, although an illustrative implementation of one or more embodiments are provided below, the disclosed systems, computer program product, and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used within the written disclosure and in the claims, the terms “including” and “comprising” are used in an open-ended fashion, and thus should be interpreted to mean “including, but not limited to.” Unless otherwise indicated, as used throughout this document, “or” does not require mutual exclusivity, and the singular forms “a”, “an” and “the” are intended to include the plural forms as well, unless the context clearly indicates otherwise.

The disclosed embodiments utilize a non-uniform underestimation approach for offline distribution reinforcement learning that produces a good policy that is more stable than the existing uniform underestimation approach for offline distribution reinforcement learning.

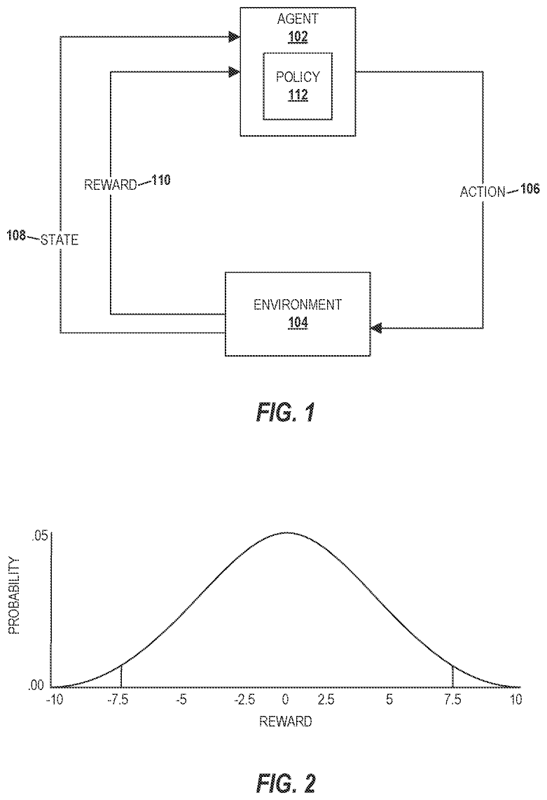

FIG. 1 is a diagram illustrating reinforcement learning in accordance with an embodiment of the present disclosure. Reinforcement learning is a type of machine learning where an agent 102 learns to make decisions based on a policy 112 by performing actions 106 in an environment 104 with the goal of maximizing the expected cumulative value of instantaneous rewards 110 over time. The agent 102 is the decision-making component hat interacts with the environment 104, receives rewards 110 for its actions 106, and updates a policy 112 accordingly. The policy 112 is a mapping from state 108 observations to actions 106, representing the agent's 102 strategy for choosing actions 106 in response to different situations.

As shown in FIG. 1, the agent 102 learns by interacting with the environment 104 by trial and error using feedback from its own actions and experiences. The environment 104 is a world in which the agent 102 operates/interacts with or is a task simulation which needs to be solved by the agent 102. The agent 102 determines what action 106 to take based on a current state 108 of the environment 104. To make decisions, the agent 102 uses observations from the environment 104, the policy 112, and any other rules that the agent 102 may be configured with. The agent 102 and the environment 104 interact continually, with the agent 102 selecting an action 106 and the environment 104 responding to the action 106 by providing an updated state 108 of the environment 104 based on the action 106. Additionally, the environment 104 provides a reward 110 (e.g., a numerical value) to the agent 102 based on the action 106. The reward 110 is high if the action 106 performed by the agent 102 is closer to achieving the intended task. The reward 110 is low if the action 106 performed by the agent 102 is not closer to achieving the intended task. As stated above, the goal of the agent 102 is to learn a policy 112 that maximizes the expected cumulative reward 110 over time.

More specifically, the agent 102 and the environment 104 interact during a sequence of discrete steps, t=0, 1, 2, 3, . . . . It should be noted that t need not be fixed intervals of real time; rather t can be arbitrary successive stages of decision-making and acting. At each step t, the agent 102 receives some representation of the environment's state 108, sₜ∈S, where S is the set of possible states of the environment 104. Based on St, the agent 102 selects an action 106, at E A(sₜ), where A(sₜ) is the set of actions available in state sₜ. One step later, based on the action aₜ, the agent 102 receives a numerical reward 110, rₜ₊₁∈R, and a new state 108 of the environment 104, sₜ₊₁. The value of an action an in state's describes the expected return/value or Q-value, or discounted sum of rewards, obtained from beginning in that state, choosing action a, and subsequently following a prescribed policy. The Q-value is determined using the Q-function Q(s, a) or the action-value function, which measures a particular action an in a particular states for a given policy. When sampled probabilistically, these state transitions, rewards, and actions can all induce randomness in the observed long-term return. Traditionally, reinforcement learning algorithms average over this randomness to estimate the expected value using a state-value function V(s), which indicates whether the environment 104 is in a good or bad state 108 for the agent 102 or how good the environment 104 is to perform a given action 106 in a given state 108. The expected value refers to the expected reward for a given state or action (i.e., the expected reward that the agent 102 can expect to receive if it takes a particular action in a particular state). As stated above, the goal is to find a policy that maximizes the expected cumulative reward over time, given the current state of the environment 104. At each step, the agent 102 implements a mapping from states to probabilities of selecting each possible action. As stated above, this mapping is called the agent's policy 112 (often denoted by symbol π, where π(a|s) is the probability that a policy, x, selects an action, a, given a current state, s). Reinforcement learning enables the agent 102 to change the policy 112 to maximize the total/cumulative amount of the reward 110 over the long run. Because this type of reinforcement learning aims to maximize the return, it is also sometimes referred to as expected value reinforcement learning.

In some circumstances or problems, it may be beneficial to learn the value/return distribution instead of the expected value. That is, the distribution over returns (all the possible returns that could occur at a given time/state and the probability of each return occurring at the given time/state) is modeled explicitly instead of modeling expected value (i.e., overall reward). This learning method is referred to as distributional reinforcement learning. Distributional reinforcement learning has been applied to a wide range of problems, including robotics, control, game playing, and recommendation systems, among others. Both traditional reinforcement learning and distributional reinforcement learning have their own strengths and weaknesses, and the choice of which to use depends on the specific problem and the desired behavior of the agent 102. For example, in a game of chess, traditional reinforcement learning may estimate that a certain move has a high expected reward because it leads to a winning position. However, if this move has a low probability of winning and a high probability of losing, it may not be the best choice from a distributional perspective. In this case, distributional reinforcement learning would provide a more nuanced and accurate assessment of the potential outcomes of each move, allowing the agent 102 to make more informed decisions.

Reinforcement learning and distributional reinforcement learning can be performed online or offline. In online reinforcement learning, the policy is updated with streaming (i.e., continuously collected) data. In contrast, offline reinforcement learning employs a dataset that is collected using some (potentially unknown) behavior policy. For example, offline reinforcement learning can use large previously collected datasets. The dataset is collected once and is not altered during the training process. The goal of the training process is to learn near-optimal policies from the previously collected data. The policy or policies are only deployed after being fully trained. Offline reinforcement learning may be beneficial in applications where actively gathering data through interactions with the environment 104 can be risky and unsafe.

A challenge to offline reinforcement learning, for both expected value reinforcement learning and distributional reinforcement learning, is accounting for high uncertainty on out-of-distribution (OOD) state-action pairs for which observational data is limited (i.e., there may be little to no information on how good or bad OOD actions are). An OOD state-action pair is an action that is performed on a state that is not in the distribution of the dataset. These are actions that the agent 102 has not encountered or seen less frequently during its training phase, and thus, its behavior in response to these actions may not be well-defined. For example, if the agent 102 is an autonomous driving agent, an OOD action may be a response to an unusual scene or object (i.e., a state) that the agent 102 did not encounter during training. If the agent 102 encounters OOD actions, its performance can be significantly degraded, as it may make suboptimal decisions or even fail completely.

One way that offline reinforcement learning handles OOD actions is to apply a pessimistic approach using uncertainty-based methods and assume all OOD actions might be dangerous, and penalize OOD actions more heavily than in-distribution actions to avoid selecting OOD actions. For example, in uncertainty-based methods, the expected value of OOD actions is underestimated (e.g., using the uncertainty of value principle). The uncertainty of value principle is a principle in reinforcement learning that states that the value of a state or action should reflect the uncertainty or variability of the future reward. Specifically, if there is more uncertainty or variability in the expected reward for a particular state or action, then the value assigned to that state or action should be lower, and vice versa. The idea behind this principle is that the value of a state or action should reflect the expected reward, but also take into account the uncertainty or variability of that reward. This can help the agent 102 make more informed decisions, as it is less likely to be misled by highly uncertain rewards. For example, consider the agent 102 is in a grid world environment, where it can move left, right, up, or down. If the agent 102 is in a state where the reward is highly uncertain, such as in a state that leads to a cliff, then the value assigned to that state should be low, as the agent 102 may fall off the cliff and receive a negative reward. On the other hand, if the agent 102 is in a state where the reward is highly predictable, such as in a state that leads to a positive reward, then the value assigned to that state should be high. The uncertainty of value principle is an important concept in reinforcement learning, as it can help improve the performance of the agent 102 by taking into account the uncertainty or variability of the expected reward.

Similar to traditional reinforcement learning, researchers have utilized the pessimistic approach to underestimate the reward distribution in distributional reinforcement learning to avoid the highly uncertain events associated with the extreme values associated with the tail portions (either high or low) of the reward distribution. The tail of a reward distribution refers to the values of the rewards that are farther away from the central tendency, or the mean, of the distribution. Events in the tail sections rarely appear in the batch data. For example, FIG. 2 is a graph illustrating an example of a return value (reward) distribution ranging from −10 to 10. It should be noted that although FIG. 2 illustrates a symmetric curve for the distribution of returns, the distribution of returns for any given state and action may vary. As stated above, by considering the full distribution of rewards, rather than just the expected value, distributional reinforcement learning provides a more complete and robust representation of the reward information, which can be useful in certain situations where the reward distribution is highly variable or has long tails. In the given example, assume that the tail of the distribution is the portion of the distribution from −7.5 to −10 and from 7.5-10 that correspond to OOD actions. The distribution of rewards can also be represented by various statistical measures such as the mean, variance, quantiles, or cumulative distribution function.

As stated above, current approaches for handling OOD actions are to underestimate the values corresponding to OOD actions. However, existing approaches “uniformly” underestimates the whole reward distribution. In contrast, the present disclosure provides various embodiments that utilize a non-uniform underestimation approach for offline distribution reinforcement learning. Embodiments of the present disclosure provide a technical solution that produces a good policy that is more stable than the existing uniform underestimation approach for offline distribution reinforcement learning.

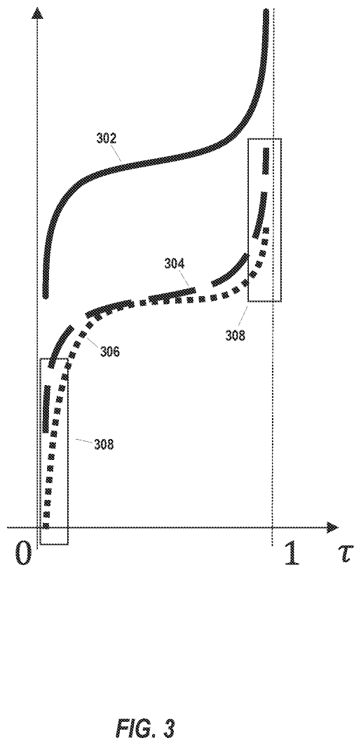

As an example, FIG. 3 is a graph representing a typical quantile function of a reward distribution. A quantile function, also known as an inverse cumulative distribution function (CDF), is the mathematical function that maps a probability or a proportion to the corresponding quantile of a distribution. For example, assuming a normal distribution with mean u and standard deviation o, the quantile function can be used to find the value x such that the probability of observing a value less than or equal to x is a certain value, (e.g., 0.95, which represents the 95th percentile of the distribution). Quantile functions are commonly used in statistics and data analysis to describe the distribution of a set of data, and can be used to calculate various measures of central tendency, dispersion, and skewness. In distributional reinforcement learning, the quantile function can be used to represent the return distribution and make decisions based on it. For instance, in FIG. 3, the quantile function 302 illustrates the return of policy It from state-action pair x=(s, a). The quantile function 302 is the true or non-underestimated return of policy π from state-action pair x=(s, a) and is represented by equation F⁻¹(τ|x), where F⁻¹ is the quantile function, t is a quantile fraction, and x is the state-action pair (s, a).

A state-action pair, also referred to as a (state, action) or (s, a) pair, is a tuple that represents a particular decision that an agent (e.g., the agent 102 in FIG. 1) has to make in a reinforcement learning environment (e.g., the environment 104 in FIG. 1). The state-action pair describes the current state of the environment and the action that the agent has selected. State-action pair is an important concept in reinforcement learning, as the goal of the agent is to learn a policy that maps states to actions, in order to maximize the expected cumulative reward. By considering both the state and the action, the agent is able to account for the effects of its actions on the environment, and choose actions that lead to desirable outcomes.

In FIG. 3, the quantile function 304 illustrates the existing approach to underestimating the return distribution for handling OOD where the whole return distribution (i.e., quantile function 302) is uniformly pushed down. The quantile function 304 can be represented by the equation F⁻¹(τ|x)=F⁻¹(τ|x)−c(x), where F⁻¹ is the quantile function, t is a quantile fraction, and x is the state-action pair (s,a), and c(x) is a (possibly uncertainty-based) uniform amount that the quantile function 302 is pushed down to produce the quantile function 304.

In contrast to the existing approach, as stated above, the disclosed embodiments utilizes a non-uniform underestimation approach for offline distribution reinforcement learning. For example, the quantile function 306 in FIG. 3 represents a non-uniform underestimation approach according to the disclosed embodiments. The quantile function 306 can be represented by the equation F⁻¹(τ|x)=F⁻¹(τ|x)−d(x, t), where F⁻¹ is the quantile function, t is a quantile fraction, and x is the state-action pair (s,a), and d(x,τ) is the (possibly uncertainty-based) non-uniform amount that the quantile function 302 is pushed down to produce the quantile function 306. As shown by the quantile function 306, the disclosed embodiments underestimate the tail portions (i.e. the extreme high/low values of the return distribution) more than other portions of the return distribution since the tail portions 308 represent more uncertain actions, and thus is more underestimated according to the disclosed embodiments than other portions of the return distribution. By underestimating the tail portions more than other portions of the return distribution, the disclosed embodiments produce a good policy that is more stable than the existing uniform underestimation approach for offline distribution reinforcement learning.

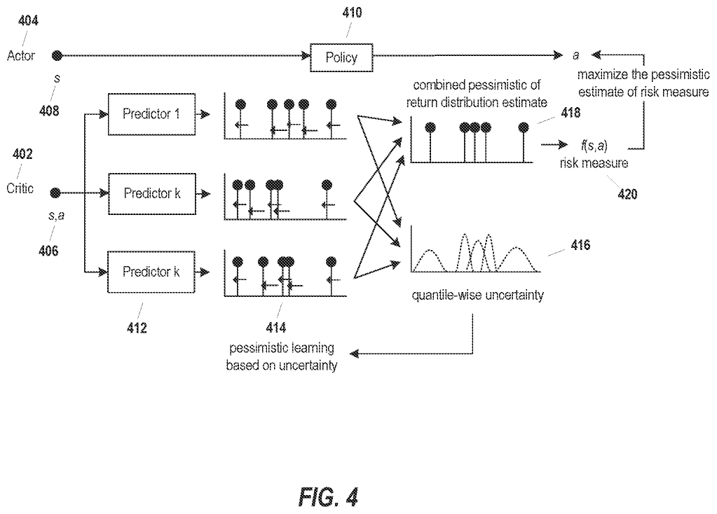

FIG. 4 is schematic diagram illustrating a non-uniform underestimation approach for offline distribution reinforcement learning in accordance with an embodiment of the present disclosure. In the depicted embodiment, a critic 402 and an actor 404 are both components of an algorithm used to learn a policy from a fixed dataset, without any additional interaction with the environment (i.e., offline). The actor 404, or agent, is a function that takes a state s 408 as input and outputs a probability distribution over actions. The actor 404 is trained to maximize the expected value of its actions, based on the critic's estimates of the value of each action in each state. In an embodiment, the goal of the actor 404 is to find a policy 410 that maximizes a risk factor as further described below.

The critic 402 evaluates the policy 410. Generally, the critic 402 is a function that estimates the expected return, or value, of being in a given state and taking a particular action (e.g., (s,a) pair 406). In an embodiment, the critic is trained to minimize the difference between its predicted values and the actual returns observed in the dataset. Together, the critic 402 and actor 404 form the basis of many reinforcement learning algorithms, including actor-critic algorithms, which use the critic's estimates to guide the actor's policy 410 updates.

In an embodiment, the critic 402 is modified to predict the return distribution instead of the expected value (e.g., using a QR-SARSA based critic). QR-SARSA is a variant of the State-Action-Reward-State-Action (SARSA) algorithm, which is a type of reinforcement learning algorithm used for learning from experience in an environment. In QR-SARSA, “QR” stands for Quantile Regression. This means that instead of estimating the expected return for each state-action pair as in traditional SARSA, a QR-SARSA critic estimates a set of quantiles for the return distribution. Quantiles are values that divide a distribution into equal-sized groups, so that, for example, the 0.5 quantile is the median.

In the depicted embodiment, the critic 402 uses a plurality of predictors 412 for computing the uncertainties for quantile estimates. A predictor 412 is a function that estimates the set of quantiles for the return distribution 414 associated with taking a given action in a given state (e.g., (s,a) pair 406). The output is typically represented as a set of probability mass functions (as represented by the five pins in FIG. 4), where each function corresponds to a different quantile of the return distribution 414. Thus, each pin represents a discretization point of the quantile function 306 in FIG. 3. The location of the pins indicates the likely probability outcome. For example, the output using Predictor 1 in FIG. 4 indicates that the middle outcome values (as indicated by the three pins in the middle) are more likely to occur then the left tail (as indicated by the left-most pin) or right tail (as indicated by the right-most pin). In contrast, the output using Predictor k in FIG. 4 indicates that the lower outcome values are more likely to occur as indicated by the four pins being more to the left of center. When the output of the predictors (e.g., Predictor 1 and Predictor k) for a (s,a) pair 406 are different, it indicates that the information on the (s,a) pair 406 is rare in the training data (i.e., associated with an OOD event), thus making it difficult to accurately predict the outcome. For these (s,a) pair 406, the disclosed embodiments will further underestimate the distribution based on the uncertainty that depends on the quantile fraction t as described herein.

The return distribution 414 from the plurality of predictors 412 are used to determine a quantile-wise uncertainty 416, which is the uncertainty associated with different quantile fractions of a distribution. In an embodiment, the quantile-wise uncertainty 416 for a quantile fraction is determined using the disagreement of the return distribution 414 (i.e., the predicted quantile values) predicted by the plurality of predictors 412 for the quantile fraction. The quantile-wise uncertainty 416 is then used to underestimate the return distribution 414 (i.e., pushed down/to the left the pins as indicated by the arrows) to apply a pessimistic learning approach based on uncertainty as discussed above. Thus, the quantile values in the return distribution 414 for the (s,a) pair 406 are more underestimated than the quantile estimates of other (s,a) pairs 406 that tend to be similar (i.e., state/action pairs corresponding to non-OOD events), which results in a non-uniform underestimation approach where the tails of the quantile function are more underestimated that other portions of the quantile function (e.g., as indicated by the quantile function 306 in FIG. 3) for offline distribution reinforcement learning.

The plurality of underestimated return distribution 414 can be combined (e.g., based on averages) into a single combined pessimistic return distribution estimate 418 and used to determine a risk measure 420. The risk measure 420 quantifies the risk associated with or the performance of the policy 410. Non-limiting examples of common risk measures include value at risk (Var), conditional value at risk (Car), expected value, entropic risk measure, and mean-variance. In an embodiment, the actor updates or selects the policy 410 so that it maximizes the pessimistic estimate of the risk measure 420. This results in a policy 410 that is more risk-averse and less likely to lead to poor outcomes.

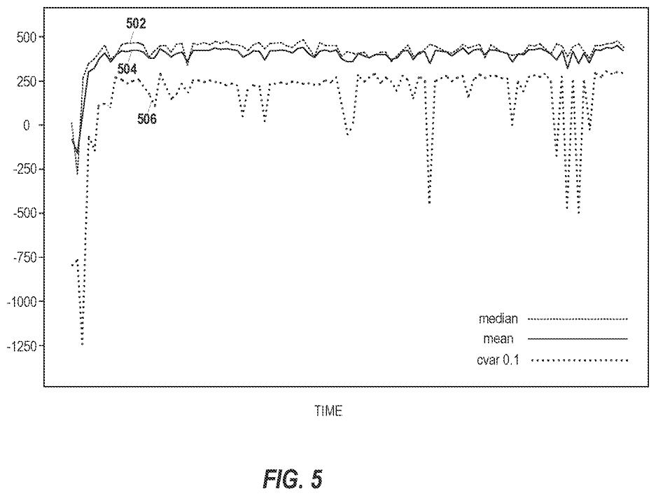

The disclosed embodiments produce a good policy that is more stable than the existing uniform underestimation approach for offline distribution reinforcement learning. By using more conservative estimates that account for uncertainty of OOD actions, the disclosed embodiments can further avoid taking actions that may have a high risk of failure. For example, FIG. 5 is a graph illustrating a non-limiting example of a return distribution of a policy that is learned using an existing uniform pessimistic approach. As shown in FIG. 5, graph 502, representing the median return, and graph 504, representing the mean return, of the return distribution are slightly different. The graph 506 indicates a risk measure of the policy (e.g., CVaR_{0.1}). CVaR_{0.1} means Conditional Value at Risk at a 10% confidence level. Otherwise stated, CVaR0.1 is the return distribution when there is a 10% chance that losses exceeds a certain threshold, called the “Var level.” As shown in FIG. 5, the graph 506 indicating the risk measure is very unstable with lots of abrupt dips and upswings.

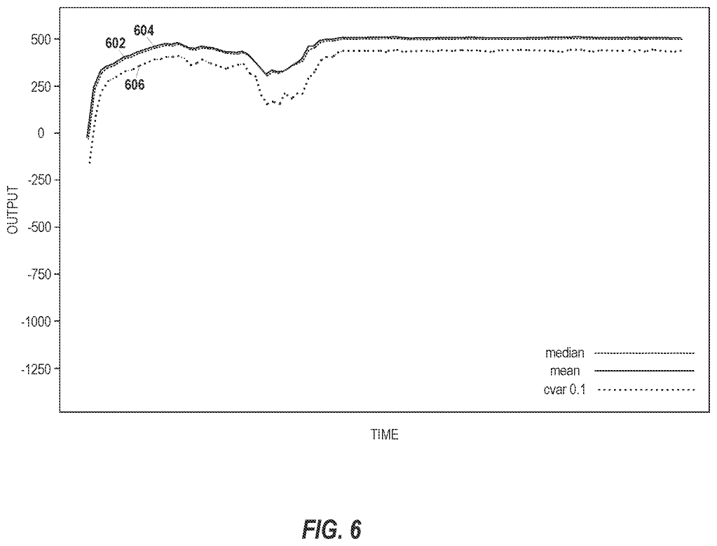

In contrast to FIG. 5, FIG. 6 is a graph illustrating a return distribution of a policy that is learned using the disclosed non-uniform pessimistic approach. As shown in FIG. 6, graph 602, representing the median return, and graph 604, representing the mean return, of the return distribution are nearly identical. Additionally, graph 606 indicates a risk measure of the policy, which is more stable (i.e., less variance) than the graph 506 in FIG. 5. Thus, using the disclosed embodiments, a more stable good policy is learned than using the existing uniform pessimistic approach.

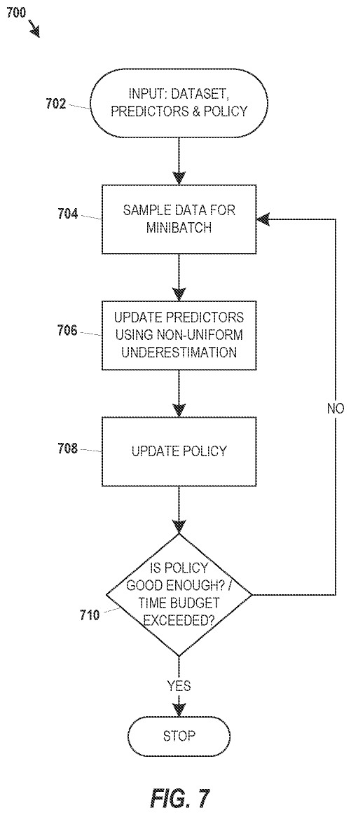

FIG. 7 is a flowchart illustrating a learning process 700 for performing offline distributional reinforcement learning in accordance with an embodiment of the present disclosure. The learning process 700 may be performed by a system (e.g., by executing an algorithm or instructions using one or more processors) configured to perform offline reinforcement learning. For example, the system may be configured to employ an agent (e.g., the agent 102) to perform offline reinforcement learning as described in FIG. 1 or actor/agent (e.g., the actor 404) and critic component as described in FIG. 4.

The process, at step 702, receives as input a dataset, the plurality of predictors, and a policy. The dataset may include training information that the agent uses during for reinforcement learning. The dataset may also include a replay buffer. A replay buffer is a data structure used in reinforcement learning algorithms that stores past experiences (i.e., state, action, reward, and next state tuples) encountered by an agent while interacting with an environment. The predictors are used to predict/estimate the return distribution for the state/action pairs as described in FIG. 4. The policy may be a baseline policy or a policy previously generated by the agent that is to be updated.

Since the dataset can be large, it is often not practical to use the entire experience replay buffer for each update. Thus, in an embodiment, to update the policy, the system, at step 704, randomly samples the dataset comprising historical training data between the agent and an environment (e.g., from its experience replay buffer) to generate a minibatch of the historical training data. A minibatch is a random subset of experiences that the system uses to update the predictors, which can improve the stability and efficiency of the learning process. The size of the minibatch is typically a parameter that can be tuned for better performance. By updating the distribution parameters with a sample minibatch, the system can efficiently learn from its experience replay buffer while avoiding overfitting to any specific experiences.

At step 706, the system updates the plurality of predictors, using non-uniform underestimation, based on the minibatch. As described in FIG. 4, in an embodiment, the system computes quantile values using the plurality of predictors for state-action pairs in the minibatch. The system then computes an uncertainty of the quantile values based on a difference or disagreement (e.g., using standard deviation) in the outputs of the plurality of predictors. The system updates the plurality of predictors based on the uncertainty of the quantile values, which results in a non-uniform underestimation of the return distribution where the tail or extreme values corresponding to OOD actions are underestimated more than other portions of the return distribution.

In an embodiment, the system updates the plurality of predictors based on the uncertainty of the quantile values using Bellman backup, quantile regression, and/or a quantile-wise penalty based on the uncertainties. The Bellman backup involves updating the predictors using the Bellman equation, which expresses the temporal relationship between the return of a state or a state-action pair and the returns of the successor states or state-action pairs. Quantile regression is a statistical technique used to estimate the conditional quantiles of the response variable as a function of the predictor variables. Quantile-wise penalty is a regularization method used in statistical modeling and machine learning to constrain the coefficients or weights of a model by applying a penalty term to the quantiles of the model coefficients.

At step 708, the system updates the policy using the updated plurality of predictors and the minibatch. In an embodiment, to update the policy, the system uses the policy to sample actions for the states in the minibatch. The system then uses the plurality of predictors to compute the quantile values for the states in the minibatch. The system computes the risk measure for the sampled actions based on the quantile values. The system updates the policy so that the risk measure is maximized. One approach to maximizing a risk measure is to use a variant of the standard objective function that includes a penalty term for the risk measure. This penalty term can be designed to reflect the desired level of risk aversion or risk tolerance. The choice of risk measure and the design of the penalty term may depend on the specific task and the goals of the agent. In an embodiment, the objective is to find a policy that balances risk and reward in a way that is optimal for the given task and environment.

At step 710, the system determines whether the policy satisfies a performance threshold (i.e., is policy good enough?) or if a time budget has been exceeded. The performance threshold may be a parameter that can be set by a user. In general, a policy can be considered good enough if it achieves high reward or performance for a given task, and if the policy is also robust and generalizable to new environments. The time budget refers to the amount of time or computational resources allocated for the learning process. This includes the time spent exploring the environment, collecting data, updating the policy, and evaluating its performance. The time budget is an important consideration in reinforcement learning, as it can have a significant impact on the learning process and the resulting policy. A larger time budget may allow for more exploration of the environment, leading to better performance and more robust policies. However, a larger time budget may also be more computationally expensive and may not be practical or feasible in all settings. If either the time budget has been exceeded or the policy satisfies the performance threshold, then the learning process 700 terminates. Otherwise, the system repeats steps 704-708 to continue the learning process 700.

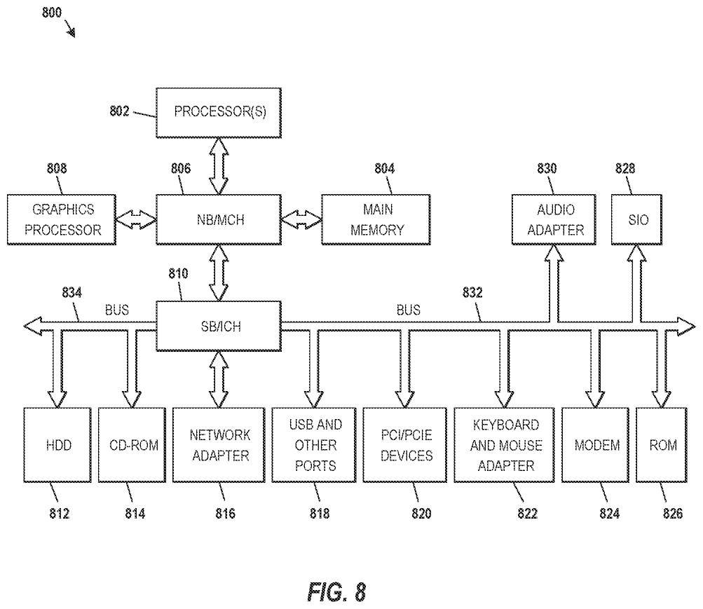

FIG. 8 is a block diagram illustrating a hardware architecture of a system 800 according to an embodiment of the present disclosure in which aspects of the illustrative embodiments may be implemented. For example, in an embodiment, the non-uniform underestimation approach for offline distribution reinforcement learning described in FIG. 4 or the learning process 700 described in FIG. 7 may be implemented using the data processing system 800. In the depicted example, the data processing system 800 employs a hub architecture including north bridge and memory controller hub (NB/MCH) 806 and south bridge and input/output (I/O) controller hub (SB/ICH) 810. Processor(s) 802, main memory 804, and graphics processor 808 are connected to NB/MCH 806. Graphics processor 808 may be connected to NB/MCH 806 through an accelerated graphics port (AGP). A computer bus, such as bus 832 or bus 834, may be implemented using any type of communication fabric or architecture that provides for a transfer of data between different components or devices attached to the fabric or architecture.

In the depicted example, network adapter 816 connects to SB/ICH 810. Audio adapter 830, keyboard and mouse adapter 822, modem 824, read-only memory (ROM) 826, hard disk drive (HDD) 812, compact disk read-only memory (CD-ROM) drive 814, universal serial bus (USB) ports and other communication ports 818, and peripheral component interconnect/peripheral component interconnect express (PCI/PCIe) devices 820 connect to SB/ICH 810 through bus 832 and bus 834. PCI/PCIe devices may include, for example, Ethernet adapters, add-in cards, and personal computing (PC) cards for notebook computers. PCI uses a card bus controller, while PCIe does not. ROM 826 may be, for example, a flash basic input/output system (BIOS). Modem 824 or network adapter 816 may be used to transmit and receive data over a network.

HDD 812 and CD-ROM drive 814 connect to SB/ICH 810 through bus 834. HDD 812 and CD-ROM drive 814 may use, for example, an integrated drive electronics (IDE) or serial advanced technology attachment (SATA) interface. In some embodiments, HDD 812 may be replaced by other forms of data storage devices including, but not limited to, solid-state drives (SSDs). A super I/O (SIO) device 828 may be connected to SB/ICH 810. SIO device 828 may be a chip on the motherboard configured to assist in performing less demanding controller functions for the SB/ICH 810 such as controlling a printer port, controlling a fan, and/or controlling the small light emitting diodes (LEDS) of the data processing system 800.

The data processing system 800 may include a single processor 802 or may include a plurality of processors 802. Additionally, processor(s) 802 may have multiple cores. For example, in one embodiment, data processing system 800 may employ a large number of processors 802 that include hundreds or thousands of processor cores. In some embodiments, the processors 802 may be configured to perform a set of coordinated computations in parallel.

An operating system is executed on the data processing system 800 using the processor(s) 802. The operating system coordinates and provides control of various components within the data processing system 800 in FIG. 8. Various applications and services may run in conjunction with the operating system. Instructions for the operating system, applications, and other data are located on storage devices, such as one or more HDD 812, and may be loaded into main memory 804 for execution by processor(s) 802. In some embodiments, additional instructions or data may be stored on one or more external devices. The processes described herein for the illustrative embodiments may be performed by processor(s) 802 using computer usable program code, which may be located in a memory such as, for example, main memory 804, ROM 826, or in one or more peripheral devices.

The disclosed embodiments may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the disclosed embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented method, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks May occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
randomly sampling a dataset comprising historical training data between an agent and an environment to generate a minibatch of the historical training data;
updating a plurality of predictors, using non-uniform underestimation, based on the minibatch; and
updating a policy using the updated plurality of predictors and the minibatch.

2. The method of claim 1, further comprising determining whether the policy satisfies a performance threshold.

3. The method of claim 1, wherein updating the policy using the updated plurality of predictors and the minibatch comprises:
sampling actions for corresponding states in the minibatch based on the policy;
computing quantile values for the states in the minibatch using the updated plurality of predictors;
computing risk measure for the sample actions from the quantile values; and
updating the policy so that the risk measure is maximized.

4. The method of claim 1, wherein updating the plurality of predictors, using non-uniform underestimation, based on the minibatch comprises:
computing quantile values using the plurality of predictors for state-action pairs in the minibatch;
computing an uncertainty of the quantile values based on a difference in outputs of the plurality of predictors; and
updating the plurality of predictors based on the uncertainty of the quantile values.

5. The method of claim 4, wherein updating the plurality of predictors based on the uncertainty of the quantile values utilizes a Bellman backup.

6. The method of claim 4, wherein updating the plurality of predictors based on the uncertainty of the quantile values further utilizes quantile regression and a quantile-wise penalty based on the uncertainty.

7. The method of claim 4, wherein updating the plurality of predictors based on the uncertainty of the quantile values comprises pessimistically estimating a quantile function of a return distribution of the plurality of predictors by shifting the quantile function according to a quantile fraction based on the uncertainty of the quantile values.

8. The method of claim 7, wherein the quantile function is represented by the equation F⁻¹(τ|x)=F⁻¹(τ|x)−d(x,τ), where F⁻¹ is the quantile function, t is the quantile fraction, x is a state-action pair (s,a), and d(x,τ) is an uncertainty-based non-uniform amount the quantile function is pushed down.

9. A system comprising memory for storing instructions, and a processor configured to execute the instructions to:
randomly sample a dataset comprising historical training data between an agent and an environment to generate a minibatch of the historical training data;
update a plurality of predictors, using non-uniform underestimation, based on the minibatch; and
update a policy using the updated plurality of predictors and the minibatch.

10. The system of claim 9, further configured to execute the instructions to determine whether the policy satisfies a performance threshold.

11. The system of claim 9, wherein the instructions to update the policy using the updated plurality of predictors and the minibatch comprises instructions to:
sample actions for corresponding states in the minibatch based on the policy;
compute quantile values for the states in the minibatch using the updated plurality of predictors;
compute risk measure for the sample actions from the quantile values; and
update the policy so that the risk measure is maximized.

12. The system of claim 9, wherein the instructions to update the plurality of predictors, using non-uniform underestimation, based on the minibatch comprises instructions to:
compute quantile values using the plurality of predictors for state-action pairs in the minibatch;
compute an uncertainty of the quantile values based on a difference in outputs of the plurality of predictors; and
update the plurality of predictors based on the uncertainty of the quantile values.

13. The system of claim 12, wherein the instructions to update the plurality of predictors based on the uncertainty of the quantile values utilizes a Bellman backup.

14. The system of claim 12, wherein the instructions to update the plurality of predictors based on the uncertainty of the quantile values further utilizes quantile regression and a quantile-wise penalty based on the uncertainty.

15. The system of claim 12, wherein the instructions to update the plurality of predictors based on the uncertainty of the quantile values comprises instructions to pessimistically estimate a quantile function of a return distribution of the plurality of predictors by shifting the quantile function according to a quantile fraction based on the uncertainty of the quantile values.

16. The system of claim 15, wherein the quantile function is represented by the equation F⁻¹(τ|x)=F⁻¹(τ|x)−d(x, t), where F⁻¹ is the quantile function, t is the quantile fraction, x is a state-action pair (s,a), and d(x,τ) is an uncertainty-based non-uniform amount the quantile function is pushed down.

17. A computer program product comprising a computer readable storage medium having program instructions embodied therewith, the program instructions executable by a processor of a system to cause the system to:
randomly sample a dataset comprising historical training data between an agent and an environment to generate a minibatch of the historical training data;
update a plurality of predictors, using non-uniform underestimation, based on the minibatch; and
update a policy using the updated plurality of predictors and the minibatch.

18. The computer program product of claim 17, wherein the program instructions to update the plurality of predictors, using non-uniform underestimation, based on the minibatch comprises instructions to:
compute quantile values using the plurality of predictors for state-action pairs in the minibatch;
compute an uncertainty of the quantile values based on a difference in outputs of the plurality of predictors; and
update the plurality of predictors based on the uncertainty of the quantile values.

19. The computer program product of claim 18, wherein the program instructions to update the plurality of predictors based on the uncertainty of the quantile values comprises instructions to pessimistically estimate a quantile function of a return distribution of the plurality of predictors by shifting the quantile function according to a quantile fraction based on the uncertainty of the quantile values.

20. The computer program product of claim 19, wherein the quantile function is represented by the equation F⁻¹(τ|x)=F⁻¹(τ|x)−d(x, t), where F⁻¹ is the quantile function, τ is the quantile fraction, x is a state-action pair (s,a), and d(x,τ) is an uncertainty-based non-uniform amount the quantile function is pushed down.
